(19) United States
(12) Patent Application Publication
(10) Pub. No.: US 2007/0276071 A1
(43) Pub. Date: Nov. 29, 2007

(54) Heat-Resistant Electrically-Insulating Composition

(76) Inventors: Christelle Mazel, Bourgoin (FR); Roland Avril, Lyon (FR)

Correspondence Address: SOFER & HAROUN LLP., 317 MADISON AVENUE, SUITE 910, NEW YORK, NY, 10017, US

(21) Appl. No.: 10/572,014

(22) PCT Filed: Sep. 10, 2004
(86) PCT No.: PCT/FR04/50422

§ 371 Date: May 10, 2007

(30) Foreign Application Priority Data
Dec. 9, 2003 (FR) 0350531

(51) Int. Cl. C08K 3/00; C09K 21/00

(52) U.S. Cl. 524/405; 524/436; 524/437; 524/80

(57) ABSTRACT

The invention relates to a heat-resistant, electrically-insulating composition which is intended, for example, for a safety cable. The invention is characterised in that the composition comprises an organic polymer, a phyllosilicate and a refractory filler.

The present invention relates to an electrically insulating composition which is further intended to resist extreme thermal conditions.

The invention finds particularly advantageous, though not exclusive, application in the domain of safety cables, that is, power or telecommunication cables for remaining operational during a defined period when they are subjected to strong heat and/or directly to fire.

These days, one of the major issues of the cable industry is improvement of the behaviour and performance of cables in extreme thermal conditions, especially those encountered during a blaze. For essentially safety reasons, it is in fact indispensable to maximise the capacities of the cable to retard the spread of flames on the one hand, and to resist fire on the other hand. With significant retardation of flames, this leaves enough time for evacuating premises and/or utilising appropriate extinction means. Better resistance to fire offers the cable the possibility of functioning for longer, with its degradation being less rapid. A safety cable should further not be a danger to its environment, that is, not discharge toxic and/or overly opaque fumes when it is subjected to extreme thermal conditions.

Whether it is electric or optic, for transporting power or for data transmission, a cable is schematically constituted by at least one conductive element extending inside at least one insulating element. It should be noted that at least one of the insulating elements can likewise play the role of protective means and/or that the cable can further comprise at least one specific protection element, forming a sheath. Now, it is known that the majority of insulating and/or protective materials utilised in cabling are unfortunately also made of excellent inflammable materials. And this is perfectly incompatible with the imperatives of the abovementioned performance in fire.

A known composition of insulating layer suitable for resisting fire is described in the patent document WO 98/43251. This composition is remarkable in that it comprises a first compound constituted by silicone rubber or an ethylene and propylene monomer or polymer, a second compound constituted by a fusible ceramic filler whereof the content can reach more than 200 parts by weight per 100 parts by weight of the first compound, as well as a third compound constituted by a refractory oxide.

This type of composition all the same has a number of significant disadvantages.

Whether in the form of a silicone rubber or d'un ethylene and propylene monomer or polymer, the first compound requires treatment by peroxide reticulation. Now, it is known that this technique proves to be economically unsatisfactory where it requires consequent equipment to be able to work under pressure, and that it does not allow high extrusion speeds to be reached.

In addition, if the fusible ceramic filler allows the formation of glass likely to ensure performance in fire of the insulator, it proves that an excessive content is prejudicial to the qualities of electrical insulation in temperature of said insulator. In fact, the melted glass has conductive properties in temperature which are all the greater when the temperature is raised.

An excessive filler rate likewise constitues a notable disadvantage, where it makes extrusion and reticulation of the composition difficult. It is proven in fact that mixtures with a high content of filler and peroxide result in a composition of high viscosity and thus in considerable auto-heating during mixing of the compounds. This elevation in temperature is then such as to cause early decomposition of peroxide and consequently the appearance of phenomenon of scorching, with the composition reticulating partially in the mixer. This phenomenon of scorching can likewise arise during extrusion following excessive mechanical auto-heating resulting from the high viscosity of the composition.

In addition, the document EP-1 245 632 is known, which divulges a composition based on polyolefin resistant to fire. This composition comprises a polyolefin, preferably 5 to 100 parts by weight of laminated silicate, and 0.1 to 10 parts by weight of metallic oxide. The problem posed by this composition is that, when it is utilised as insulation on an electric cable, it does not permit prolonged functioning of the latter, or in other terms, it does not ensure the electrical integrity of the cable in the event of fire.

Finally, document GB-2 367 064 is known, which likewise discloses a composition based on polyolefin resistant to fire. This composition comprises a polyolefin, preferably 0.01 to 10 parts by weight of nanocomposite clay such as montmorillonite, and a metallic oxide in a proportion of around 200 parts by weight. The problem posed by this composition is that, when it is utilised as insulation on an electric cable, the ashes formed by the mineral fillers (including the nanocomposite clay) exhibit insufficient cohesion leading to dropping of ashes in the event of fire, thus not ensuring the mechanical and electrical integrity of the cable, that is, its continued functioning in the event of fire.

The invention solves these problems by ensuring an optimal compromise between the electrical insulation properties, mechanical performance and thermal insulation of the insulator. To achieve this, it proposes a resistant electrically and thermally insulating composition especially for safety cables, characterised in that it comprises an organic polymer, at least 15 parts by weight of the composition of a phyllosilicate and at least 50 parts by weight of the composition of a refractory filler.

Phyllosilicates, which are the commonest forms of clays, are compounds constituted by a set of sheets whereof the individual dimensions are of the order of a nanometre in thickness and several tens of nanometres in length. This particular feature confers a very high surface coefficient, of the order of 100 to 1000 m²/g, as well as a very strong form factor, since the length/thickness ratio can reach 100.

Phyllosilicates also have two important interdependent characteristics: capable of dispersing in particles composed of a small number of sheets, capable of going as far as the insulated sheet in certain conditions, as well as being capable of modifying their surface properties at will, by simple cationic exchange.

Accordingly, phyllosilicates have the capacity of intercaler compounds organics tels que des polymers between their sheets. In concrete terms, when repulsion forces between the atoms of the organic compound exceed the attraction forces between the sheets, this produces delamination of the material in sheets, resulting in a hybrid structure in which said sheets are dispersed over the matrix of organic compound.

The material thus obtained actually constitutes a nanocomposite, since it is in the presence of particles of less than a micron in size, dispersees in an organic matrix. This type of structure is characterised by relatively strong internal interactions which are such as to engender physico-chemical properties and functions different to those of the matrix considered as insulation.

It has surprisingly been found that the integrity of an electrical cable is maintained in the event of fire when the insulation of its conductors is obtained from a composition according to the present invention, comprising a sufficient proportion both of the phyllosilicate and the refractory filler, whereas in the compositions of the prior art the systems comprised either a large proportion of phyllosilicate and little refractory filler, or a strong proportion of refractory filler and little phyllosilicate.

In any case, the composition according to the present invention generates a substantial improvement in mechanical and thermal properties and the gas barrier of polymers filled with this type of filler. This consequently explains the strong capacities for resistance to the extreme thermal conditions offered by any electrically insulating composition according to the present invention.

According to a preferred embodiment of the invention, the phyllosilicate is of organophilic type.

In fact, the improvements in the abovementioned properties are strongly associated with the state of dispersion of the phyllosilicate filler within the polymer matrix. Now, control of this dispersion passes by the maîtrise of interactions between the different sheets of the inorganic material and the organic matrix. It consequently proves preferable to pretreat the surface of the phyllosilicate used so as to confer on it a more organophilic character, and thus to allow the organic compound, in this instance a polymer, to penetrate easily between the sheets.

On a molecular scale, such treatment can be carried out easily by substituting the hydratable inorganic cations present on the surface of each sheet, a surfactant which will generally be a quaternary ammonium, for example in the form of alkylammonium ions. This type of surfactant has a hydrophilic polar head which easily replaces the cations of the phyllosilicate, as well as an aliphatic hydrophobic chain more or less long which thus makes the sheet organophilic. This modification helps increase the distance between the sheets and thus facilitate penetration of the polymer.

It should be noted that the phyllosilicate can of course be natural or synthetic.

In a particularly advantageous way, the rate of phyllosilicate is less than or equal to 50 parts by weight per 100 parts by weight of organic polymer.

This rate is preferably between 20 and 30, and advantageously approximately equal to 20.

The organic polymer is preferably a copolymer comprising at least ethylene. Of course, as the composition can comprise several different organic polymers, the invention relates implicitly to any mixture based on a copolymer comprising at least ethylene.

The organic polymer is advantageously an ethylene-octene copolymer. For the same reason as above, the invention is implicitly relative to any mixture based on ethylene-octene copolymer.

The rate of refractory filler in the composition is preferably between 100 and 200, on the one hand to obtain the optimal effect in terms of integrity, and on the other hand to allow easy use of the composition according to the present invention as insulation on a cable.

The refractory filler is preferably selected from magnesium oxide (MgO), silicon oxide (SiO₂), aluminium oxide (Al₂O₃) and muscovite mica (6 SiO₂-3 Al₂O₃-K₂O-2H₂O), or any mixture of these compounds, or even from the precursors of these compounds.

These precursors which decompose into oxide under the action of heat can contribute to the reinforcement of the fireproofing of the mixture.

According to a particular feature of the invention, the composition further comprises a fusible ceramic filler.

In practice, this fusible ceramic filler has a melting point of under 500° C., such that it is can be transformed into glass as soon as it is subjected to higher temperatures, which is quasi systematically the case during a fire. In these extreme thermal conditions, that is, when the polymer has been completely degraded, the layer of hard ceramic thus formed then advantageously completes the action of the phyllosilicate by reinforcing the mechanical performance of the whole. But it likewise participates indirectly in maintaining the electrical insulation of the conductor, by facilitating the ceramisation of the refractory filler which then takes the feed of the polymer in terms of electrical insulation.

The fusible ceramic filler is preferably selected from boron oxide (B₂O₃), zinc borates (4ZnO B₂O₃ H₂O or 2ZnO 3B₂O₃ 3,5H₂O) and boron phosphates (BPO₄) anhydres or hydrates, or any mixture of these compounds.

In a particularly advantageous manner, the rate of fusible ceramic filler is less than or equal to 50 parts by weight per 100 parts by weight of polymer.

According to another particular feature of the invention, the composition is advantageously realisee by silane reticulation, for example by the Sioplas process.

In fact, even though the composition can be obtained simply by thermoplastic mixing, it is however preferable for it to be carried out by silane reticulation, where constitution of a network of strong chemical bonds is such as to reinforce even more the performance in temperature, but also mechanical, of said composition.

In this hypothesis, reticulation by the Sioplas process will be preferred relative to peroxide reticulation, since it requires clearly less substantial equipment on the one hand, and since it enables higher extrusion speeds on the other hand. Also, such reticulation does not exert any pressure on the support to which the composition is applied, as it is conducted at atmospheric pressure or at very low water vapour pressure, contrary to peroxide reticulation which is conventionally carried out under vapour tube at high pressure.

It should be noted that if a fusible ceramic filler should be part of a composition to be reticulated by sioplas technique, zinc borate would then be the most appropriate compound to play the role of said filler.

According to a currently preferred first specific embodiment of the invention, the composition comprises:
100 parts by weight of organic polymer based on at least ethylene-octene copolymer,
100 to 200 parts by weight of magnesium oxide,
15 to 50 parts by weight of phyllosilicate.

According to a second specific currently preferred embodiment of the invention, the composition comprises:
100 parts by weight of organic polymer based on at least ethylene-octene copolymer,
100 to 200 parts by weight of muscovite mica,
15 to 50 parts by weight of phyllosilicate.

It should be noted that in both cases, the proportion of organic polymer corresponds to the overall quantity of polymer present in the composition, irrespective of the number of distinct polymers composing the mixture. Accordingly, the proportion of organic polymer can implicitly designate strictly either 100 parts by weight of ethylene-octene copolymer, or 100 parts by weight of a mixture based on ethylene-octene copolymer.

The invention likewise relates to any cable comprising at least one conductive element extending inside at least one insulating element, and whereof at least one insulating element is constituted by a composition such as described hereinabove.

The invention additionally relates to any cable comprising at least one conductive element coated by an internal insulating layer and an external insulating layer, said internal insulating layer being constituted by a composition according to the first specific embodiment and said external insulating layer being constituted by a composition according to the second specific embodiment. The cable in question thus benefits from bilayer insulation. The ensemble is arranged such that in the event of extreme thermal conditions the internal insulating layer more specifically ensures insulation electrical of the conductive element with which it is directly in contact, whereas the external insulating layer more particularly guarantees the overall mechanical performance of said cable.

Other characteristics and advantages of the present invention will emerge from the following description of examples, said examples being given by way of illustration and in no way limiting.

Table 1 hereinbelow illustrates the surprising results obtained by means of a composition according to the present invention, and especially the influence of the rate of phyllosilicate on the integrity of an electrical cable utilising a composition according to the present invention.

TABLE 1

| | Duration of integrity in | |
|---|---|---|
| Rate of | a fire resistance test | Conformity of |
| phyllosilicate | of type EN 50200 | cable according |
| (pcr) | (T° flame = 830° C. U-500 | to EN 50200 |
| 0 | Less than 5 minutes | Non-conforming |
| 5 | 5 to 7 minutes | Non-conforming |
| 10 | 6 to 10 minutes | Non-conforming |
| 15 | Greater than 15 minutes | Conforming |
| 20 | Greater than 60 minutes | Conforming |
| 25 | Greater than 60 minutes | Conforming |
| 30 | Greater than 60 minutes | Conforming |

wherein pcr represents the parts by weight per 100 parts resin and U represents the electrical tension between phases.

Table 1 hereinabove clearly shows that the electrical integrity of an electrical cable whereof the insulation contains all concentrations equal additionally and according to the present invention, at least de 15 parts by weight of phylosillicate, is surprisingly maintained, while it is not maintained below 15.

Examples 1 to 5 more particularly concern compositions for serving insulating layers for power and/or telecommunication cables.

### EXAMPLE 1

Table 2 details the respective proportions of the different constituents of an intermediary composition (formula A) which is intended for elaboration of two electrically resistant and thermally resistant compositions.

TABLE 2

| | |
|---|---|
| Formula A | 75 pcr ethylene-octene copolymer |
| | 25 pcr ethylene-ester acryl copolymer |
| | 100 to 200 pcr muscovite mica |
| | 0 to 60 pcr aluminium trihydrate or magnesium dihydrate |
| | 5 to 15 pcr wax |
| | 0 to 5 pcr zinc oxide |
| | 2 a 15 pcr silane |
| | 2 to 5 pcr antioxidant |
| | 5 to 15 pcr reticulation agent |

wherein pcr represents the parts by weight per 100 parts of resin.

The composition 1 defined in Table 3 hereinbelow corresponds to a typical composition of the prior art, since it associates with a polymer matrix and a refractory filler, a fusible ceramic filler constituted in this example by zinc borate. The composition 2 defined in Table 3 below is according to the present invention in terms of the fact that it associates with a matrix polymer and a refractory filler a phyllosilicate filler which is present in identical proportion.

As per Table 3, tests were conducted to evaluate the cohesion of ashes when such compositions are subjected to increasingly high temperatures.

TABLE 3

| | Composition 1 | Composition 2 |
|---|---|---|
| | Formula A + 20 pcr | Formula A + 20 pcr |
| Temperature | zinc borate | phyllosilicate |
| 400° C. | no cohesion | no cohesion |
| | black ashes | black ashes |
| 500° C. | no cohesion | start of cohesion |
| | grey ashes | dark drey ashes |
| 600° C. | start of cohesion | weak cohesion |
| | grey ashes | dary grey ashes |
| 700° C. | weak cohesion | strong cohesion |
| | white ashes | grey ashes |
| 800° C. | strong cohesion | cohesion |
| | white ashes | white ashes |

It is observed very clearly that the presence of phyllosilicate in place of the fusible ceramic filler helps noticeably to increase the cohesion of the ashes, and this over a wide range of temperatures.

From a mechanical point of view, the performance in fire of an insulator constituted by a composition according to the present invention is consequently significantly improved.

Tests were also conducted to determine the insulation electrical capacity at high temperature of compositions 1 and 2 described hereinabove. In this respect, the standardised CEI 60331 test reveals that the composition 2 gives clearly better results than composition 1, and this all the more so since the tensions applied are considerable.

Finally, it is proven that composition 2 remains electrically insulating and thermally resistant over a wide range of temperatures from ambient temperature to around 1100° C.

### EXAMPLES 2 TO 5

By way of indication other examples of compositions according to the present invention are specified hereinbelow. Examples 2 and 3 listed in Table 3 concern compositions based on mica as refractory filler, whereas Examples 4 and 5 of Table 4 are more particularly relative to compositions based on magnesium oxide as refractory filler.

It is especially evident that phyllosilicate never makes up the majority filler, a role systematically held by the refractory filler.

TABLE 3

| | |
|---|---|
| Example 2 | 55 pcr ethylene-octene copolymer |
| | 25 pcr ethylene-propylene-diene terpolymer |
| | 20 pcr ethylene-ester acrylic copolymer |
| | 100 to 200 pcr mica |
| | 15 to 50 pcr phyllosilicate |
| | 0 to 60 pcr aluminium trihydrate or magnesium dihydrate |
| | 5 to 15 pcr wax |
| | 0 to 5 pcr zinc oxide |
| | 2 to 15 pcr silane |
| | 2 to 5 pcr antioxidant |
| | 0 to 15 pcr reticulation agent |
| Example 3 | 75 pcr ethylene-octene copolymer |
| | 25 pcr ethylene-ester acrylic copolymer |
| | 100 to 200 pcr mica |
| | 15 to 50 pcr phyllosilicate |
| | 0 to 60 pcr aluminium trihydrate or magnesium dihydrate |
| | 5 to 15 pcr wax |
| | 0 to 5 pcr zinc oxide |
| | 2 to 15 pcr silane |
| | 2 to 5 pcr antioxidant |
| | 5 to 15 pcr reticulation agent |

wherein pcr represents the parts by weight per 100 parts of resin.

TABLE 4

| | |
|---|---|
| Example 4 | 75 pcr ethylene-octene copolymer |
| | 25 pcr ethylene-ester acrylic copolymer |
| | 100 to 200 pcr magnesium oxide |
| | 15 to 50 pcr phyllosilicate |
| | 0 to 60 pcr aluminium trihydrate or magnesium dihydrate |
| | 5 to 20 pcr wax |
| | 2 to 15 pcr silane |
| | 2 to 5 pcr antioxidant |
| | 0 to 15 pcr reticulation agent |
| Example 5 | 75 pcr ethylene-octene copolymer |
| | 10 pcr ethylene-ester acrylic copolymer |
| | 15 pcr ethylene-propylene-diene terpolymer |
| | 100 to 200 pcr magnesium oxide |
| | 15 to 50 pcr phyllosilicate |
| | 0 to 60 pcr aluminium trihydrate or magnesium dihydrate |
| | 5 to 20 pcr wax |
| | 2 to 15 pcr silane |
| | 2 to 5 pcr antioxidant |
| | 0 to 15 pcr reticulation agent |

wherein pcr represents the parts by weight per 100 parts of resin.

1. An electrically insulating and thermally resistant composition especially for a safety cable, comprises: an organic polymer, at least 15 parts by weight of the composition of phyllosilicate and at least 50 parts by weight of the composition of a refractory filler.

2. The composition as claimed in claim 1, wherein the phyllosilicate is of organophilic type.

3. The composition as claimed in claim 1, wherein the rate of phyllosilicate is less than or equal to 50 parts by weight per 100 parts by weight of organic polymer, and preferably between 20 and 30 parts by weight per 100 parts by weight of organic polymer, and preferably even approximately equal to 20 parts by weight per 100 parts by weight of organic polymer.

4. The composition as claimed in claim 1, wherein the organic polymer is a copolymer comprising at least ethylene.

5. The composition as claimed in claim 1, wherein the organic polymer is an ethylene-octene copolymer.

6. The composition as claimed in claim 1, wherein the rate of refractory filler is between 100 and 200 parts by weight per 100 parts by weight of organic polymer.

7. The composition as claimed in claim 1, wherein the refractory filler is selected from magnesium oxide, silicon oxide, aluminium oxide and muscovite mica, any mixture of these compounds or even from the precursors of these compounds.

8. The composition as claimed in claim 1, further comprises a fusible ceramic filler.

9. The composition as claimed in claim 8, wherein the fusible ceraminc filler is selected from boron oxide, zinc borates and the boron phosphates, or any mixture of these compounds.

10. The composition as claimed in claim 8, wherein rate of fusible ceramic filler is less than or equal to 50 parts by weight per 100 parts by weight of polymer.

11. The composition as claimed in claim 1, wherein it is produced by silane reticulation.

12. The composition as claimed in claim 1 further it comprises:
100 parts by weight of organic polymer based on at least de ethylene-octene copolymer,
100 to 200 parts by weight d'magnesium oxide,
15 to 50 parts by weight of phyllosilicate.

13. The composition as claimed in claim 1 further comprises:
100 parts by weight of organic polymer based on at least de ethylene-octene copolymer,
100 to 200 parts by weight of mica muscovite,
15 to 50 parts by weight of phyllosilicate.

14. A cable comprising at least one conductive element extending inside at least one insulating element, wherein least one insulating element is constituted by a composition as claimed in claim 1.
